(19) United States
(12) Patent Application Publication
(10) Pub. No.: US 2016/0087842 A1
(43) Pub. Date: Mar. 24, 2016

(54) METHOD OF OPERATING A COMMUNICATION NETWORK

(71) Applicant: NOKIA SOLUTIONS AND NETWORKS OY, Espoo, OT (FI)

(72) Inventors: Haitao Tang, Espoo (FI); Henning Sanneck, Munich (DE); Seppo Olavi Hamalainen, Espoo (FI); Lars Christoph Schmelz, Haar (DE)

(21) Appl. No.: 14/785,736

(22) PCT Filed: Apr. 30, 2013
(86) PCT No.: PCT/EP2013/059002

§ 371 Date: Oct. 20, 2015

(51) Int. Cl. H04L 12/24; H04W 24/02

(52) U.S. Cl. CPC H04L 41/0866; H04W 24/02

(57) ABSTRACT

A method of operating a communication network comprising a verification component is provided, wherein the method comprises achieving at the verification component a verification plan defining a verification process associated with a specific network operation; and executing the verification plan after deploying the specific network operation.

### FIELD OF INVENTION

The present invention relates to the field of method of operating a communication network, in particular a mobile communication network. In particular, it relates to a method of verifying an action of a network configuration. Furthermore, the invention relates to a network entity a communication network. Moreover, the invention relates to a program element, and a computer-readable medium.

### ART BACKGROUND

A communication network, such as a cellular network, typically comprises a plurality of network elements, e.g. base stations, communicating with each other and with user equipment, e.g. mobile phones, PDAs or laptops, or the like. The network elements and/or user equipments may implement a number of network functions, such as self-organizing network (SON) functions. These network functions may require the configuration of certain network parameters during their operation by providing or sending respective requests to reconfigure or changing the network parameters.

SON coordination function would reject those requests if they would cause or engage in conflicts with other network functions, if they were allowed to take their requested actions. SON coordination function would approve the other configuration requests. These approved configuration requests will trigger the actual configuration of their corresponding network parameters. However, it is not guaranteed that all these approved network configurations would for sure lead to the improved performance targeted by the corresponding network functions and, even more so for the network-wide performance defined by operator specific criteria.

### SUMMARY OF THE INVENTION

Thus there may be a need to provide a method of operating a communication network, a network entity, a computer readable medium and a program element enabling an improved performance of the communication network.

This need may be met by a method of operating a communication network, a network entity, a computer readable medium and a program element according to the independent claims. Further embodiments are described by the dependent claims.

According to an exemplary aspect a method of operating a communication network comprising a verification component is provided, wherein the method comprises achieving at the verification component a verification plan defining a verification process associated with a specific network operation; and executing the verification plan after deploying the specific network operation.

In particular, the verification plan may be created by the network component itself or may be received at the network component together with a configuration request. Alternatively or additionally, the verification plan may be received independently to a configuration request, in particular in advance of a configuration request, e.g. when providing the verification component with a specific network component, subcomponent or element.

According to an exemplary aspect a method of determining a verification plan defining a verification process in a communication network is provided, wherein the method comprises providing verification policy clauses at a network entity, and determining a verification plan based on the verification policy clauses at the network entity.

In particular, the verification policy clauses are associated with a performance of the communication network and/or with characteristics and/or features of a respective network operation. For example, the network entity may be physical entity, e.g. a computing system or some machine-level component, of a network vendor, or may be run by a network vendor or may be manufactured by a network vendor. Thus, it may be said that the network entity “is” a network vendor. Alternatively, the network entity may be a physical entity, e.g. computing system, of an operator or may be a site or place run by an operator of the communication network. Thus, it may be said that the network entity “is” an operator of the communication network (in the same sense as described above) or any other network entity having at which knowledge of the specific needs and specific capabilities of a specific network operation is present.

After determining, creating or developing the verification plan, the verification plan may be sent or may be transmitted to a verification component or entity, e.g. site operated by an operator. However, it is also possible that the verification component or the respective entity the verification component resides on itself is involved in or participate in the creation of the verification plan. For example, the verification component may reside on the network entity defining the verification policy clauses or defining at least one verification clause or portion thereof.

According to an exemplary aspect a network entity for a communication network is provided, wherein the network entity is adapted to perform a method according to an exemplary aspect.

According to an exemplary aspect a program element is provided, which, when being executed by a processor, is adapted to control or carry out a method according to an exemplary aspect.

According to an exemplary aspect a computer-readable medium is provided, in which a computer program is stored which, when being executed by a processor, is adapted to control or carry out a method according to an exemplary aspect.

The term “verification plan” may particularly denote a set of meta data which may be used to determine or verify whether a performed or requested configuration action relating to the communication network fulfils specific and/or predetermined criteria. These criteria may relate to the network performance, for example.

For example, the verification plan may define guidelines or rules which can be used or which are suitable to decide whether a performed change of a configuration of a communication network could be allowed or not. In particular, a change of the configuration may only be allowed in case the performance, e.g. with respect to failures, data capacity or bandwidth of the communication, of the communication network is increased or at least not decreased by the new configuration.

The term “network operation” may particularly denote any operation or service performed in the communication network. The network operation may be defined by network functions, for example.

The term “network entity” may particular denote any physical entity in the communication network, e.g. a computer system, a base station or the like.

The term “verification policy clauses” may particular relate to a set of rules which provide some kind of general framework which has to be fulfilled by the verification plan. Thus, these “verification policy clauses” are considered when determining or creating the verification plan”. The verification policy clauses or at least some of the verification policy clauses may be defined by a network vendor and/or an operator of the communication network and/or standards relating to communication network, and/or any entity running or providing a network entity which is part of the communication network.

The term “verification component” may particularly denote a component adapted and/or suitable to perform the verification process. For example, the verification component may be a program, algorithm or set of rules according to which the verification process is performed. In particular, the “verification process” may be performed by a computing unit with or without interaction with a human being, e.g. an operator. Thus, the “verification component”, e.g. a program, may run totally independent of a human being, may run while interacting with a human being, or may be run or performed by a human being, e.g. an operator.

In particular, the verification process may be a process which is suitable to verify whether a specific network operation fulfils predefined verification policy clauses, i.e. is in line with these verification policy clauses or not. These verification policy clauses may be suitable to tell or decide whether the communication network is functioning as expected or desired.

In particular, a method according to an exemplary aspect may enable an efficient verification process and thus may be suitable to improve performance of the communication network. For example, it may be possible to overcome a characteristic of current self-organizing network (SON) coordination function which focuses only on the detection and coordination of conflicts known in advance. Using a method according to an exemplary aspect it may be simplified that a network component, e.g. a program run at a network entity relating to an operator, can compensate this disadvantage by adding the post-action verification to make sure if a configuration action really provides improvement or not. If not improved, the network component may optionally roll-back the configuration action or may trigger the roll-back.

Summarizing a gist of an exemplary aspect may be to provide a method of operating a communication network. In particular, the method may enable to verify whether a specific new configuration of network operations or of the communication network increases a performance, e.g. a network-wide performance, of the communication network. For efficiently deciding whether a new configuration of network operations increases the performance or not a verification plan is used by the network component for the verification which network plan is provided to the network component, e.g. in advance or with a configuration request, alternatively the network plan may be determined or created by the network component itself. In such a verification plan information otherwise not present at the network component may be provided to the network component, for example and therefore possibly enabling an efficient post-action verification. Optionally, the post-action verification may be designed as an extension to the SON coordination function or designed as an individual entity to manage the network configuration.

Due to the use of a verification plan which defines the verification process it may also be possible to reduce the time needed for post-action verification, since the network component can focus on the issues needed for the verification. Thus, it may be easier to fulfil a practical time limit of the post-action verification, which is advantageously be done quickly after a configuration action with as few available performance feedback data as possible (e.g., KPI samples). Otherwise, there may be no chance to rollback if desired.

In particular, the method according to an exemplary aspect may ensure that the network component and/or the operator of a network entity the network component runs on has sufficient knowledge of the network functions which are not designed by the network component and/or the operator of the network entity.

Next, further exemplary embodiments of the method of operating a communication network are described. However, these embodiments also apply to the method of determining a verification plan, the network entity, the program element, and the computer-readable medium.

According to an exemplary embodiment of the method the verification component is run on a site of an operator of the communication network.

In general, the network component may be run on any site or entity which is capable of performing the verification process. For example, an entity managed by a network operator may run the network component. Alternatively or additionally a dedicated or specialized entity or network entity may run the network component, wherein the entity or network entity is dedicated for this specific task and which is independent of a network operator.

According to an exemplary embodiment of the method the verification plan provides meta data associated with network functions.

In particular, the network functions may define the network operation or may correspond to the network operation. Examples for the meta data may be network function ID;

self-organizing network function ID; network resources, e.g. cells, base stations or the like, which has to be configured when performing the specific network operation (e.g. cell ID); the resources impacted but not directly configured when performing the specific network operation or when performing the configuring of the specific network operation; specific performance indicators which are monitored (e.g. dropped called ratio) and their respective values which are collected and/or calculated from specific network entities; a value defining a specific number of samples needed to be taken in order to achieve a reliable result during the verification process; and threshold or classification values of the specific performance indicators.

According to an exemplary embodiment of the method the verification plan defines at least one performance indicator.

According to an exemplary embodiment of the method the verification plan defines threshold values of the at least one performance indicator.

In particular, the threshold value may define whether a communication network quality or performance associated with the specific performance indicator is sufficient. For example, more than one or all defined performance indicators may be characterized or associated by a threshold value. Additionally or alternatively, the verification plan may also define or provide the information from which network entity of the communication network values of the performance indicator(s) can be collected or requested from. Some examples of usable performance indicators or key performance indicators may be a number of too late handovers; number of handovers to wrong cell (from target cell to source cell via a 3^{rd} cell); short stay handovers (handover from source cell to a 3^{rd} cell from where handover to target cell soon after); or Number of RLFs. The defined threshold values of or for the at least one performance indicator may then be used for a verification by just comparing the threshold value with an actual measured or determined value for the at least one performance indicator, e.g. may define a threshold per key performance indicator (KPI) which may be directly applied to a KPI time series. Alternatively or additionally the threshold value may relate to a normalized difference between KPI distributions, e.g. to a normalized difference between different KPI time series.

According to an exemplary embodiment the method further comprises defining at least one verification policy clause before the network plan is achieved by the verification component.

In particular, the verification policy clauses may be defined by the verification component or a network entity on which the verification component is running. For example, the network entity may relate or may be operated by an operator of the communication network. The policy clauses may be defined in the form of “event”, “condition”, and “action” For example, the event and conditions may be defined based on defined or selected performance indicators and their corresponding values. It should be noted that predetermined threshold values may be defined for the defined or selected performance values, which may be different for different specific network entities or network elements. That is, for different network elements different threshold values may be defined. In case the selected performance indicator reaches or assumes the threshold value the action may be defined as “accept” while in case the threshold value is not reached the action may be defined as “reject”. In particular, the verification policy clauses may define parameters or performance indicators and their respective values defining whether the communication network is functioning as expected or exhibit a performance which fulfils a predetermined quality or performance level.

According to an exemplary embodiment the method further comprises receiving an indication indicative that a configuration of the specific network operation has been completed, wherein the executing of the network plan is performed after receiving the indication.

According to an exemplary embodiment the method further comprises collecting information needed for executing the verification plan.

For example, information may be collected which is necessary for the decision whether the deployed specific network operation may be acceptable, e.g. fulfils a predetermined performance level, for the communication network. In particular, the verification plan may define a verification process and may be based on collected or monitored information or meta data. The knowledge of this information or meta data may be needed to perform or execute the verification plan.

The network plan may be determined or created at any network entity having sufficient knowledge of the specific network operation. Thus, it may be created at a network entity operated by a network vendor which is advantageously provided with policy clauses in advance or by the network component which is provided with the needs of the specific network operation in advance, for example. Alternatively, the network entity may be operated or run by an operator of the communication network.

Summarizing the provision of a verification plan may ensure that a post-action verification of a specific configuration action can succeed, since the verification plan and thus the network function corresponding to the verification plan requesting the configuration action may tell the respective network component, e.g. a program or algorithm run on a network entity of an operator, or the operator himself what are the specific performance indicators to look at, what their specific performance values indicate, and what are the network entities (e.g., cells) where those performance indicators should be collected and reviewed.

The aspects and exemplary embodiments defined above and further aspects of the invention are apparent from the example of embodiment to be described hereinafter and are explained with reference to these examples of embodiment.

### BRIEF DESCRIPTION OF THE DRAWINGS

FIG. 1 schematically shows an SON verification process.

FIG. 2 is a flowchart of a method according to an exemplary embodiment.

### DETAILED DESCRIPTION

The illustration in the drawing is schematic.

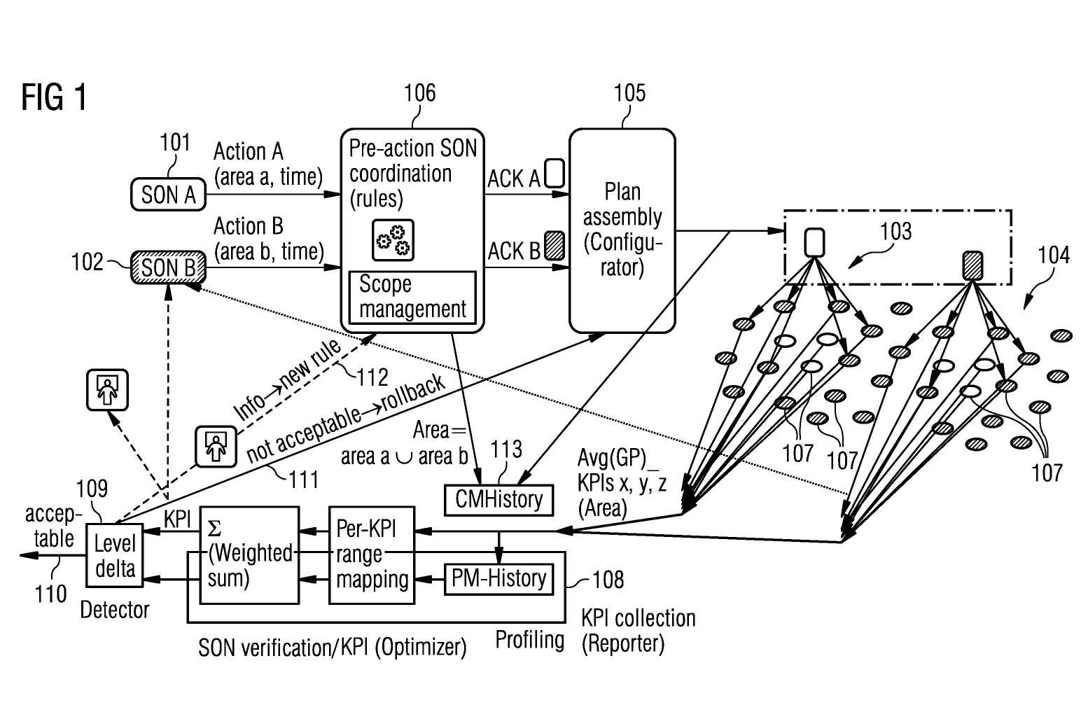

In the following a detailed description of exemplary embodiments is given. In particular, a process of self-organizing network (SON) coordination and SON verification using a key performance indicator (KPI) or aggregated KPI is schematically shown in FIG. 1. For example, two SON functions 101 and 102 are defined which are relevant or used for a respective area 103 and 104, respectively. Each of the two SON function corresponds to a specific action A and B, respectively. For each of the two SON functions a respective verification plan is assembled, configured or created 105 based on pre-action SON coordination, e.g. on based on policy clauses or rules 106 of a network component, e.g. an operator of a communication network. After a configuration request for the SON function is transmitted and approved the SON functions are configured in their respective areas 103 and 104.

The configuration or re-configuration of the SON-functions changes only some of a plurality of network elements 107, which are schematically indicated by the white circles in FIG. 1. The effects of the configuration or re-configuration on the network elements and/or the performance of the communication network is measured and analyzed during the SON-verification, schematically depicted as 108. During the SON-verification an (aggregated) KPI is calculated based on the verification plan taking into account a plurality of meta data or information, e.g. performance management history, KPIs which are weighted with respect to each other. This KPI is then used by a network component or detector 109 in order to decide whether a configuration request is acceptable 110 or not 111, wherein in the latter case the configuration may be rolled-back to the configuration before and/or may trigger a modification of the policy clauses or rules 112. For the decision some diagnosis logic evaluating each KPI component of the aggregated KPI plus the aggregated KPI itself may be added. In particular, the KPI may be a time series of some counter, some low level aggregation of performance indicators (PIs), and/or some higher level aggregation of key performance indicator. The PI and/or KPI computation or determining may include some statistical computation. In particular, the statistical computation may go beyond a simple averaging like characterizing or analyzing a certain chronological distribution, for example. Furthermore, the configuration may be stored in a configuration management (CM) history 113.

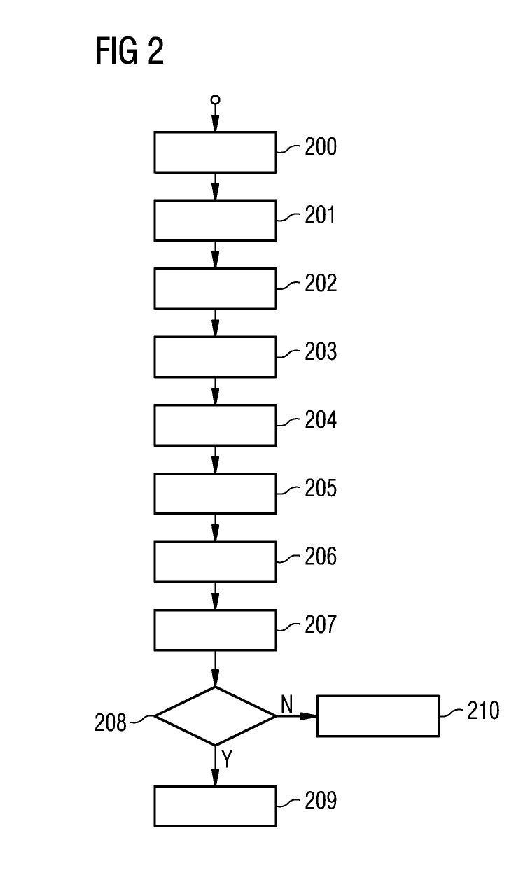

FIG. 2 is a flowchart of a method according to an exemplary embodiment. In a first step 200 a network component, e.g. a program or algorithm running on a network entity operated by an operator, defines a set of verification policy clauses (i.e., a verification policy set) that tell whether the whole network is functioning as expected according to the network component or not. The policy clauses may be defined in the form of “event”, “condition”, and action”. For example the events and conditions could be defined based on selected performance indicators and their acceptable values for specific network entities, e.g., cells. The actions might be defined as “Accept” or “Reject”. In a next step 201 at a network entity, e.g. at a site of a network vendor, a verification plan is created or determined, based on the verification policy clauses received by the network entity. Alternatively, the network component or a program run at a network entity operated by an operator of the communication network may create the verification plan. For this alternative it is advantageous that the network component or the site at which the network component is running receives some information in advance concerning the specific network operation to which the verification plan corresponds or relates to. Afterwards (step 202) the verification plan is sent to the network resource or the network entity the network component for performing a verification process is run. This may be performed during a specific network operation. For example, if a network function requests a configuration of certain network parameters (step 203), this network function also provides the verification plan concerning this intended configuration.

Afterwards the network entity which then performs the verification process, i.e. runs the network component, may approve the specific configuration request of a network function (step 204). If a configuration request is approved and the actual configuration action has been taken, a configuration-completed indication may be sent to the network component (step 205). When the network component receives the configuration-completed indication (step 206), the network component may start the corresponding verification process based on the corresponding verification plan and operator policies (step 207).

The verification component can run fully- or semi-automated or be under manual supervision of a human operator. Typically, due to the availability of performance management (PM) data only in “granularity periods”, i.e., not instantaneously, also the deployment on new configurations happens only in certain intervals (typically being identical to the granularity period (e.g., in hourly intervals). This in turn means that in a certain network area not only one but potentially many configuration changes will happen. Then typically the union or entirety of the verification plans will be the input to the verification process. Instead of the entirety only a subset of the verification plans may be the input, e.g. in case some (statistical) pre-processing is performed by which the subset may be defined.

After or during performing the verification process it is checked and decided (step 208) according to the verification plan whether the configuration request can be approved (step 209), i.e. does improve the net-wide performance or at least does not decrease it, or whether it should rather dismissed and the configuration should be rolled-back to the original configuration (step 210).

In particular, the verification process may comprise the following steps:
(1) Execute the corresponding verification plan(s) by collecting needed information for the plan(s) and then make verification decision based on the plan(s). The verification decision based on the plan(s) could be “Good”, “OK”, or “Bad”, for example. However, the results may also be discrete or continues values. a) If the verification decision is “Bad”, go to step “(4)”. For the case of several, potentially spatially overlapping verification plans, a specific diagnosis component trying to identify the root cause (individual configuration change) could be added. In the simplest variant, verification plans would be executed separately and if any of them leads to a “Bad” decision, all configuration changes in the affected area could be set to “Bad” (and thus be rolled back).
(2) Optionally the verification component may check if there are any of the performance indicators (specific to the plan(s)) that have led to a “reject” action by comparing them through the network component's verification policy set.
   a) If yes, go to step “(4)”.
(3) The verification component approves the already taken configuration action and concludes the verification process.
(4) The verification component rollbacks the already taken configuration action and concludes the verification process.

In the following a more detailed example of a verification plan and the information provided by the verification plan is given.

The verification plan for a specific configuration request made by a specific network function may be defined to provide the following information (function “meta data”), including (but not limited to),
1. Network SON function ID.
2. The network resource or resources to be configured (e.g., cell ID).
3. The entities impacted but not directly configured by this intended configuration (e.g., cell ID).
4. The specific (key) performance indicators to be monitored (e.g., Dropped Called Ratio: DCR), which are collected and calculated from specific network entities.
5. For example, specific number of samples needed by each specific performance indicator before a reliable verification can be made on the performance indicator. Alternatively or additionally, some description or statistical measure may be used instead.
6. The classification values of the specific performance indicators, so that the operator knows if the monitored value of a performance indicator is in the scope of “Bad”, “OK”, or “Good.” In the simplest case this corresponds to fixed thresholds like 0-x% for “Good”, x%-y% for “OK” and >y% for “Bad”, e.g., for the DCR mentioned above. For some performance indicators, the classification could also be derived by the system in operation itself (“profiling”) and hence no configuration of classification values in the plan would be required.

A specific example may be the verification for mobility load balancing which may be as follows. MLB (Mobility Load Balancing) adjusts handover parameters to shift boundary between over-loaded cell and a neighbour cell that can receive excess traffic from over-loaded cell. A risk of moving users by moving cell boundaries is that handover performance between two cells becomes poor. Therefore a verification plan may involve checking of handover performance for two cells in question. Selected mobility related key performance indicators (KPIs) could be e.g.
Number of too late handovers
Number of handovers to wrong cell (from target cell to source cell via a 3^{rd} cell)
Short stay handovers (handover from source cell to a 3^{rd} cell from where handover to target cell soon after)
Number of Radio Link Failures (RLFs)

For all mobility related KPIs values should be in acceptable range, especially if mobility robustness optimization (MRO) function cannot be triggered.

Other parameters relevant for MLB would be e.g. load levels for target cell and neighbours for target cell. If target cell load would exceed a threshold value, MLB action should not be accepted. Target cell could also collect load information from its neighbours—if CAC (Composite Available Capacity) values of (many of the) neighbours would indicate that system is highly loaded in this area, it might be better to try to find another cell to which excess traffic would be steered.

The presented invention may provide the advantage that it is not necessary for the operator to know/implement verification separately for each SON function and their versions. Instead each SON function (possibly from multiple different network vendors) and version of SON function may have verification plan attached that is passed to the verification component. Furthermore, it should be noted that for SON-coordination, i.e. the process of coordinating different SON-functions, e.g. by providing specific rules for the different SON-functions, it may as well not be necessary to know/implement verification separately for each SON function and their versions.

Finally, it should be noted that the above-mentioned embodiments illustrate rather than limit the invention, and that those skilled in the art will be capable of designing many alternative embodiments without departing from the scope of the invention as defined by the appended claims.

In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

### LIST OF REFERENCE SIGNS

101 SON-function

102 SON-function

103 Area

104 Area

105 Assembling verification plan

106 Policy clauses

107 Network elements

108 SON-verification

109 Network component

110 Accepting configuration

111 Dismissing configuration

112 Modifying policy clauses

113 Configuration management history

200 Defining set of verification policy clauses

201 Creating verification plan

202 Sending verification plan

203 Requesting configuration of network parameters

204 Approving configuration request

205 Sending configuration-completed indication

206 Receiving configuration-completed indication

207 Starting corresponding verification process

208 Checking the configuration request

209 Approving configuration

210 Dismissing configuration

1. A method of operating a communication network comprising a verification component, the method comprising:
achieving at the verification component a verification plan defining a verification process associated with a specific network operation; and
executing the verification plan after deploying the specific network operation.

2. The method according to claim 1, wherein the verification component is run on a site of an operator of the communication network.

3. The method according to claim 1, wherein the verification plan provides meta data associated with network functions.

4. The method according to claim 1, wherein the verification plan defines at least one performance indicator.

5. The method according to claim 4, wherein the verification plan defines threshold values of the at least one performance indicator.

6. The method according to claim 1, further comprising:
defining at least one verification policy clause before the network plan is achieved by the verification component.

7. The method according to claim 1, further comprising:
receiving an indication that a configuration of the specific network operation has been completed, wherein the executing of the network plan is performed after receiving the indication.

8. The method according to claim 1, further comprising:
collecting information needed for executing the verification plan.

9. A method of determining a verification plan defining a verification process in a communication network, the method comprising:
providing verification policy clauses at a network entity; and
determining a verification plan based on the verification policy clauses at the network entity.

10. A network entity for a communication network, wherein the network entity is adapted to perform a method according to claim 1.

11. A program element, which, when being executed by a processor, is adapted to control or carry out a method according to claim 1.

12. A computer-readable medium, in which a computer program is stored which, when being executed by a processor, is adapted to control or carry out a method according to claim 1.
